(19) United States
(12) Patent Application Publication
(10) Pub. No.: US 2014/0175125 A1
(43) Pub. Date: Jun. 26, 2014

(54) Beverage dispenser and related methods

(71) Applicant: Michael John Breault, Redlands, CA (US)

(72) Inventor: Michael John Breault, Redlands, CA (US)

(21) Appl. No.: 14/134,309

(22) Filed: Dec. 19, 2013

Related U.S. Application Data
(60) Provisional application No. 61/739,466, filed on Dec. 19, 2012.

(51) Int. Cl. B67D 7/74

(52) U.S. Cl. CPC B67D 1/004; B67D 1/0059
USPC 222/129.1

(57) ABSTRACT

The present invention relates to a beverage dispenser configured to dispense variable serving sizes of cold beverages. The present invention uses the Venturi effect in order to mix the syrup and water at a constant ratio.

### CROSS-REFERENCE TO RELATED APPLICATIONS

This application claims the priority and benefit of U.S. Prov. Pat. App. Ser. No. 61/739,466 (filed Dec. 19, 2012) and entitled “Full serve, compact beverage dispenser for the home that dispenses cold, carbonated and non-carbonated flavored drinks,” which provisional patent application is hereby incorporated by reference in its entirety.

### STATEMENT REGARDING FEDERALLY SPONSORED RESEARCH OR DEVELOPMENT

Not applicable.

### BACKGROUND OF INVENTION

1. Field of the Invention

The disclosed subject matter is in the field of beverage dispensers.

2. Background of the Invention

A beverage is a liquid drink for human consumption. Beverage varieties include, but are not limited to: water, alcoholic drinks, non-alcoholic drinks, carbonated drinks, fruit or vegetable Juice, and hot drinks (e.g., coffee, tea, and hot chocolate). Beverages of any variety are consumed by the general population on a daily basis.

Beverages, other than water, frequently involve complicated or lengthy preparations. As a result, large quantities of premade beverages are frequently canned or bottled for later consumption. Consuming canned or bottled beverages can be problematic. For instance, bottled or canned beverages, once opened, must be consumed within a relatively short period to avoid spoliation of the beverage (e.g., the flattening of a carbonated soda). Also, bottled or canned beverages can result in waste, particularly in the case of aluminum cans and plastic bottles. Finally, canned and bottled soda typically lacks the freshness of soda dispensed from a soda fountain.

To avoid spoliation and to adjust serving sizes, sometimes beverages are sometimes dispensed from a dispenser that mixes a concentrate flavoring, or syrup, with a base fluid like water. For instance, traditional soda fountains and dispensers have been in existence for years and use bag-in-box (BIB) pumps to deliver syrups to a mix system. The traditional systems mix the beverage components (i.e. carbon dioxide, water, or syrup) via motors and contain numerous moving parts. Additionally, these dispensers are too large and expensive to be practical for home use. Instead, soda dispensers are mostly used commercially in establishments like restaurants, bars, and convenience stores.

Recently, there have been some developments in beverage makers or dispensers for home use. For instance, sodastream is a machine that allows a user to mix carbonated beverages at home. To use the sodastream, a reusable 1 L bottle that is only compatible with sodastream is placed into a pump so that carbon dioxide may be pumped into the water. Later, the carbonated water can be mixed with syrup to make a carbonated beverage. One downside of sodastream is that it does not create single servings of carbonated beverages. It must be mixed in 1 L batches, and not variable single servings. Another downside of the sodastream is that the user manually measures and mixes the syrup and carbonated water, which can lead to inconsistent flavors if a user adds too much or too little syrup.

While there is very little in the area of at home single serving carbonated beverage dispensers, there are several products available for making single servings of hot, noncarbonated beverages. Products like Keurig® and Nesspresso® allow a user to brew a single cup of coffee or other hot beverage. To use one of these devices, a user places a premeasured disposable cup of coffee grounds, dried tea, or another hot beverage mix in the machine. The machine then introduces a predetermined amount of hot water through the cup to “brew” the beverage. The machine then dispenses the hot drink. Because both the coffee and the water are premeasured, the single cup coffee makers will only make hot drinks in discreet sizes.

Most recently Santioemmo (U.S. Pat. No. 8,250,972) taught a device that can dispense single servings of carbonated beverages. Santioemmo's device works similar to single serve coffee machines—it uses premeasured amounts of syrup and mixes it with a predetermined amount of water. Santieommo's device mixes soda in a machine, but it can only do so in discrete serving sizes. For example, Santieommo's device might have three possible settings, such as 6 oz, 12 oz, and 16 oz. If the machine had only those three settings, a user would be unable to dispense a drink that was 10 oz.

In view of the foregoing, a need exists to create a machine that dispenses cold beverages of variable sizes but at a small scale suitable for home use.

### SUMMARY OF THE INVENTION

It is an object of the present invention to provide a dispenser of carbonated drinks that is small enough for at home use.

It is another object of the present application to dispense carbonated drinks in variable serving sizes.

It is another object of the present invention to dispense non-carbonated drinks in addition to carbonated sodas.

It is another object of the present invention to dispense cold, chilled drinks in variable quantities and with consistent flavor.

In one embodiment, disclosed is a beverage dispenser capable of making and dispensing cold beverages comprising: a water source; a chiller; a flavor port; a flavor injector; and a discharge port for dispensing the beverage. Suitably, the water source may be a live water line, the chiller may be a thermoelectric chiller. For carbonated beverages, the dispenser may further comprise a carbon dioxide port.

In another embodiment, disclosed is a method of making a beverage in a beverage maker comprising: chilling water in a water source; pumping the water the past the outlet of a flavor injector; and dispensing said water. In this method, syrup may suitably be sucked into the flavor injector using the Venturi effect to create a flavored beverage.

### BRIEF DESCRIPTION OF THE FIGURES

The manner in which these objectives and other desirable characteristics can be obtained is explained in the following description and attached figures in which:

FIG. 1 is a perspective view of the soft drink dispenser.

FIG. 2 is front view of the flavor injector inside the dispenser.

FIG. 3 is a top view of the flavor injector.

FIG. 4 is a perspective view of a flavor bullet.

FIG. 5 is a front view of a flavor bullet.

FIG. 6 is a top view of a flavor bullet.

FIG. 7 is a side view of a flavor bullet.

FIG. 8 is a side view of a flavor bullet with the top open and the cap off as it will be used in the dispenser.

FIG. 9 is a closer perspective view of the flavor port.

FIG. 10 is a rear perspective view of the dispenser.

FIG. 11 is an interior view of the flavor injector.

FIG. 12 is an interior view that shows how the flavor injector and the flavor bullet interact.

FIG. 13 is a diagram that shows the preferable method of mixing carbon dioxide and water.

### DETAILED DESCRIPTION OF THE INVENTION

Disclosed is a beverage dispenser capable of making and dispensing cold beverages comprising: a water source; a chiller; a flavor port; a flavor injector; and a discharge port for dispensing the beverage. Disclosed is a method of making a beverage in a beverage maker comprising: chilling water in a water source; pumping the water the past the outlet of a flavor injector; and dispensing the water. In this method, syrup may suitably be sucked into the flavor injector using the Venturi effect to create a flavored beverage.

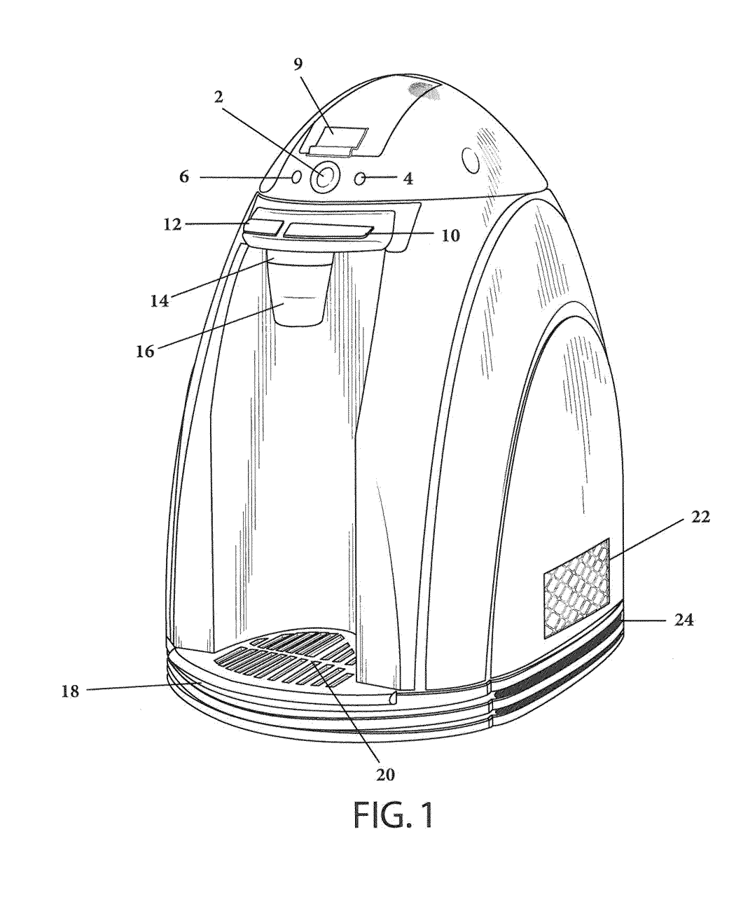

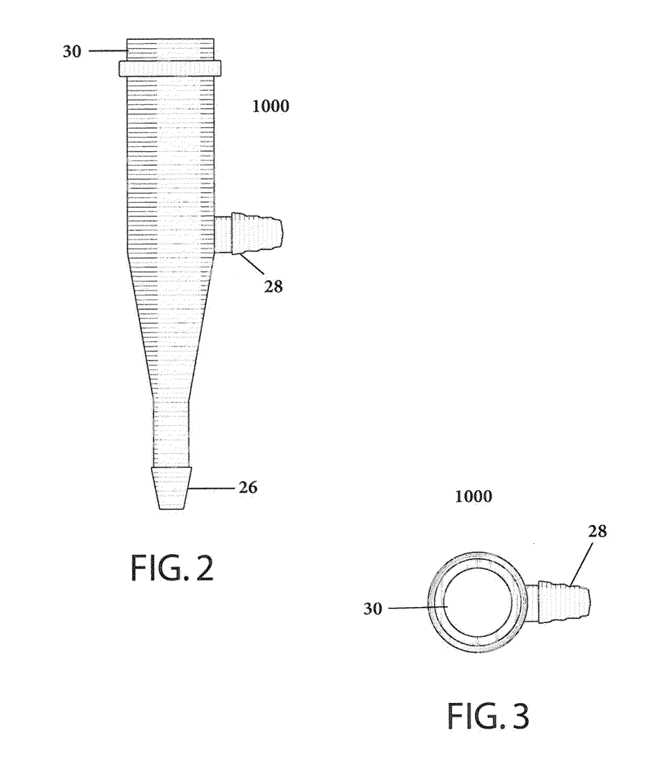

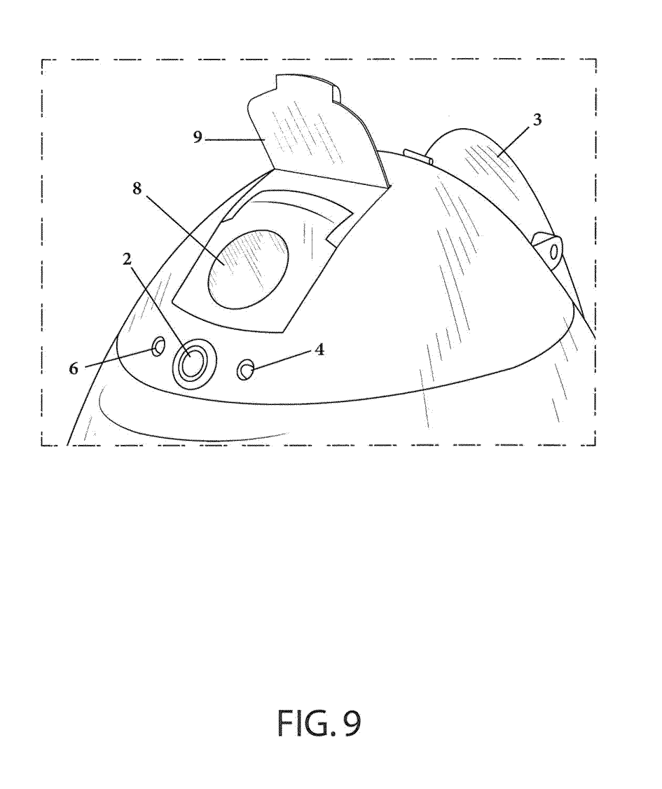

FIG. 1 is a front perspective view of the preferred embodiment of the drink dispenser machine as it is assembled for use. In this particular embodiment, the machine features a parabolic-type shape. The exterior of the machine can be made of durable plastic capable of withstanding hot or cold temperatures. When using the dispenser, a user turns the machine on and off with the power button 2. The power button is located near the top of the machine in the center. On either side of the power button are two lights. The carbon dioxide light 4 is suitably located on the right of the power button 2. The carbon dioxide light 4 turns red when the machine needs a refill of carbon dioxide. On the left of the power button 2 is a water light 6. The water light 6 will turn red when the machine needs a refill of water. Just above the power button 2 is the door 9 to the flavor port 8 (see FIG. 9). The flavor port 8 opens and closes so that the user can insert a flavor bullet 2000 (see FIG. 3) inside of the drink dispenser. The flavor bullet contains a concentrated drink mix that will blend with either still water or soda water to create a beverage.

Underneath the power button 2 and lights are two additional buttons. The soda water dispensing button 10 is located on the right. When the soda water dispensing button 10 is pushed, the machine will dispense a carbonated beverage in a steady stream. If there is no flavor bullet 2000 inserted in the flavor port 8, then the machine will dispense straight soda water. If there is a flavor bullet in the flavor port 8, then the machine will dispense a flavored, carbonated beverage of choice. While the soda water dispensing button 10 is being pressed, the machine will continue to dispense the beverage. This allows a user to choose the serving size he/she wishes to consume. By pressing the soda dispensing button 10 for a short time, the machine will dispense a small amount of beverage. If a user presses the soda dispensing button 10 for a longer period of time, then the machine will dispense a larger serving of beverage.

To the left of the soda water dispensing button 10, is the water dispensing button 12. When a user pushes the water dispensing button 12, the machine will dispense non-carbonated water if there is no flavor bullet in the flavor port 8. If there is a flavor bullet in the flavor port 8, then the machine will dispense a non-carbonated drink, such as juice or sports drink. The water dispensing button 12 typically works like the soda dispensing button 10. A user can choose the serving size based on the length of time he/she holds down on the water dispensing button 12.

When the drink dispenser dispenses a beverage, the contents, i.e. syrup and water, flow through the flavor diffuser 14. The diffuser 14 aids in mixing the syrup and water by slowing down the flow of the liquids. The diffuser 14 may be a commercially available product or it may be a diffuser 14 specially fitted to accompany the present invention. The diffuser 14 aids in making the taste of the beverages consistant. The diffuser 14 is made of a dishwasher safe plastic and can be easily washed to maintain a consistent quality to the drinks. Once the drink has been mixed in the diffuser 14, the drink will be dispensed through the nozzle 16. The nozzle 16 will also be made of a dishwasher safe material and is capable of being removed and replaced.

At the base of the machine, there is a drip tray 18 and a splash guard 20. The drip tray 18 is a shallow container at the base of the machine. The drip tray 18 can trap liquid that inadvertently drips from the nozzle 16. A splash guard 20 covers the top of the drip tray 18. The splash guard 20 has a grill like surface that allows liquids to trickle into the drip tray 18. The splash guard 20 minimizes splash that might occur from an accidental spill. Both the drip tray 18 and the splash guard 20 are removable and made of a dishwasher safe material.

The drinks that are dispensed from the machine are preferably cold by virtue of a thermoelectric chiller 22. The thermoelectric chiller 22 works by having current flow through two conductors. The thermoelectric chiller 22 uses thermoelectric technology to chill the temperature of the water so that drinks dispensed from the machine are at a cool temperature as if they had just come out of a refrigerator. When current flows through two different conductors, heat can be generated or removed at the junction point. A thermoelectric mechanism creates a hot sink and a cold sink and heat can be extracted away from the chiller using a fan. The cold sink lowers the temperature of the water. This is similar to technology found in dispensers that dispense cold filtered water. When the power to the machine described in the present invention is turned on, the thermoelectric chiller 22 will begin to chill water stored in the machine. If the user choses to connect the machine to a live water line, the thermoelectric technology will work in a similar manner to filtered water dispenser.

Just below the thermoelectric cooler 22 is a light 24. In this embodiment, the two strips just below the cooler light up when the machine is turned on. The light 24 provides illumination if the lighting is minimal. The machine can also be made without the light 24.

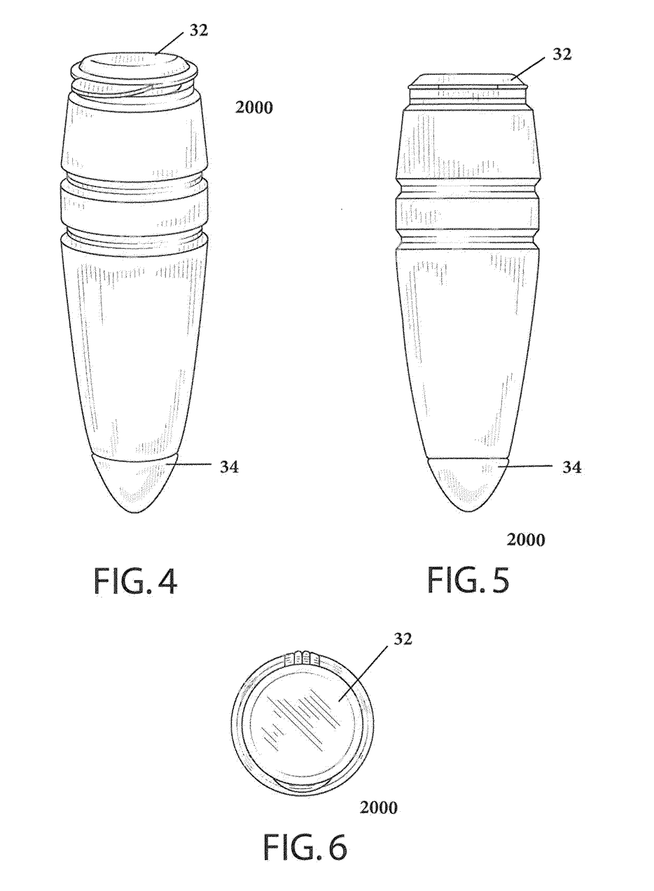

FIG. 3 is a side view of the flavor injector 1000. The flavor injector 1000 is an interior component of the machine. The flavor injector 1000 is used for injecting syrup into a stream of water at a premeasured ratio. The flavor injector 1000 has three openings, a water inlet 26, a syrup inlet 28, and a beverage outlet 30. The water inlet 26 is located at one end of the flavor injector 1000 and will be connected to a water supply. The syrup injector 28 is on the top of the flavor injector and a flavor bullet 2000 (see FIG. 4) will sit over top of the syrup inlet 28. The beverage outlet 30 will connect to the diffuser 14.

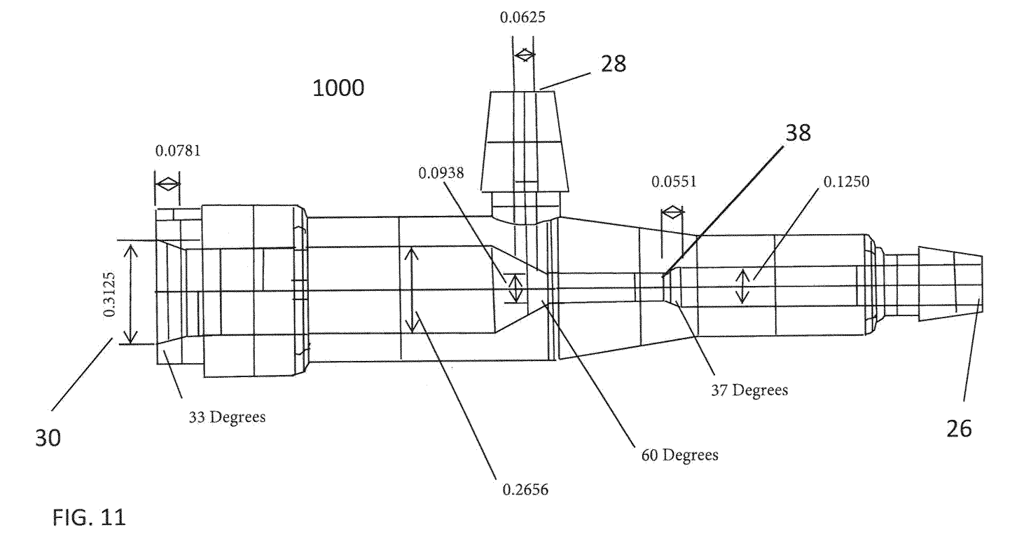

When water flows through the water inlet 26, there is a choke point 38 (see FIG. 11) in the interior of the flavor injector 1000. The choke point creates a Venturi effect. A Venturi effect is the name given to a reduction in fluid pressure when fluid flows through a constricted section of a pipe. The choke point causes flow rate to increase and pressure to decrease inside the flavor injector 1000. The change in pressure creates a suction effect at the syrup injector 28 which causes the syrup to be sucked into the flavor injector 1000. The consistent flow rate created by the Venturi effect ensures that the syrup/water ratio remains constant. This allows a user to self-select a preferred serving size. Once the water and syrup are mixed inside of the flavor injector 1000, the blended drink flows through the beverage outlet 30 to the diffuser 14.

FIG. 3 is a top view of the flavor injector 1000.

FIG. 4 is a perspective view of the flavor bullet 2000. The flavor bullet 2000 is a sleek plastic container that contains syrup. The syrup can come in many different flavors such as cola, lemon-lime, root beer, and ginger ale. In this embodiment, for example, the flavor bullet 2000 might contain two ounces of syrup. At the top of the flavor bullet is a hinged lid 32. The lid 32 allows the flavor bullet 2000 to be opened at the top so that a user can refill the flavor bullet 2000 with additional syrup. The lid allows a user to pour any increment of flavor into flavor bullet 2000, reseal it, and reuse it later. At the bottom of the flavor bullet 2000 is a cap 34. The cap 34 covers a hole 36 (see FIG. 8) at the bottom of the flavor bullet 2000.

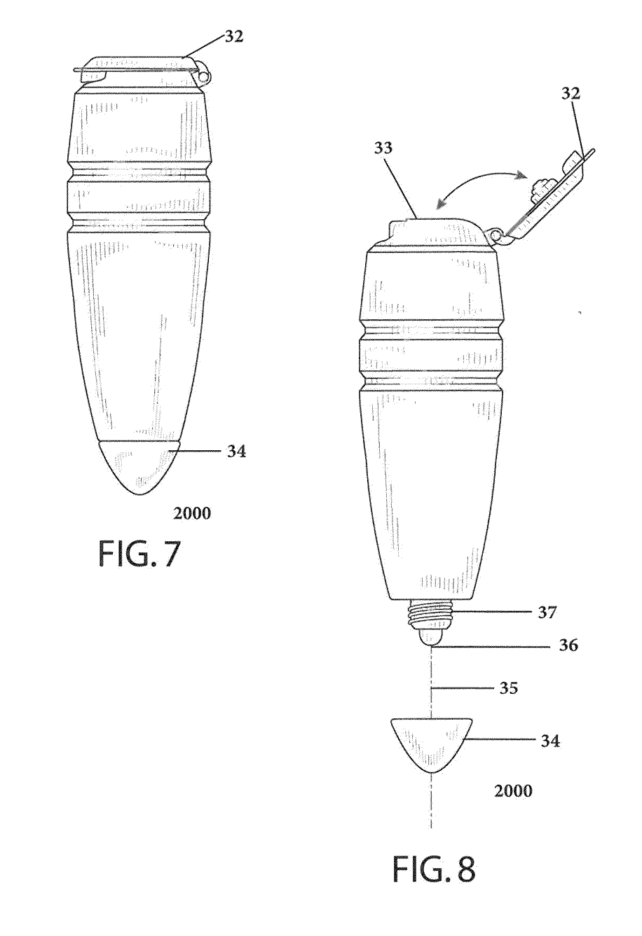

FIGS. 4, 5, and 7 show front, top, and back views of a preferable flavor bullet.

FIG. 8 shows a flavor bullet 2000 dispensing syrup 35. There are two openings in the flavor bullet, one opening 33 at the top and hole 36 at the bottom. The size of the top opening 33 varies from flavor to flavor and is determined by the brix ratio required by the syrup inside. For instance, a real juice flavored drink requires a larger opening 33, allowing a larger amount of syrup to flow. Juice drinks are typically brixed at a ratio of three parts water to one part syrup. A natural cane sugar ratio is typically five parts water and one part syrup and is a smaller opening 33 is required. A diet flavor is typically eight parts water and one part syrup and will have the smallest orifice 33.

There is a hole 36 in the bottom of the flavor bullet 2000. The bottom hole 36 in the cartridge 2000 is the vacuum hole and should only be opened when the cartridge is 2000 firmly attached to the drink machine. This also gives the user the flexibility of resealing the cartridge 2000 and not using all of the contents at one time. When the flavor bullet 2000 is in the machine, syrup will flow out of the hole 36 into the flavor injector 1000. The flavor bullet 2000 also features a threaded section 37 which allows the cartridge 2000 to fit snugly into the drink machine, ensuring consistent suction.

FIG. 9 is a close up view of the flavor port 8, into which a flavor bullet 2000 may be inserted. The figure shows the door 9 to the flavor port 8 open. When the door 9 to the flavor port 8 is open, a flavor bullet 2000 can be inserted into the flavor port 8. The hole 36 in the flavor bullet 2000 will line up with the syrup inlet 28 in the flavor injector 1000.

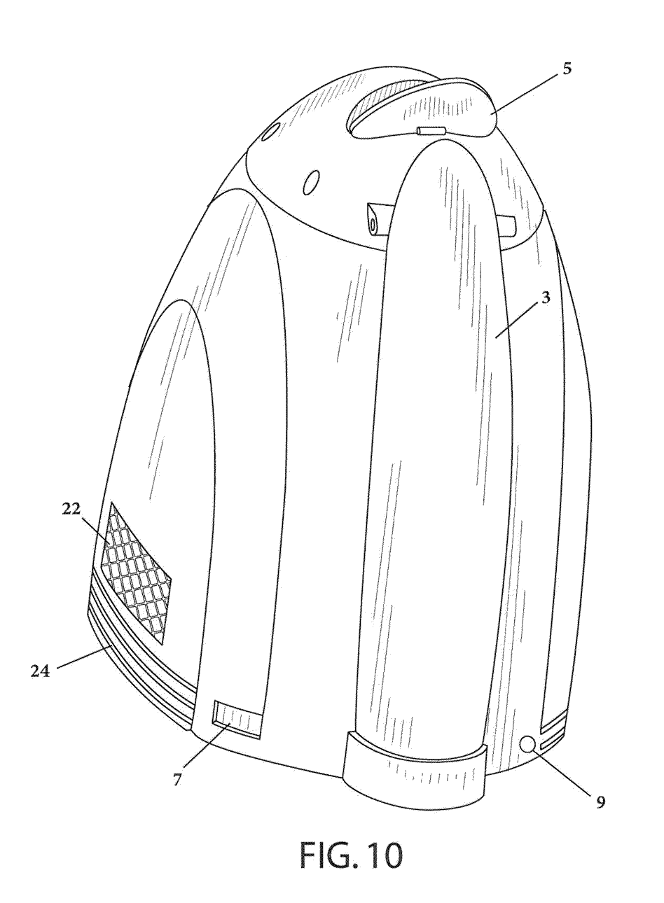

FIG. 10 is a back perspective view of the dispenser. On the bottom left hand side is the plug 7. An AC adapter will connect the drink dispenser to a wall outlet, which will supply power to the dispenser. In the preferred embodiment, the plug 7 will be compatible with commercially available AC adapters.

At the top of the machine is a water access hatch 5. The machine can be supplied with water in one of two ways. Water can be poured directly into the water access hatch 5. In the preferred embodiment of the invention, the drink dispenser holds up to two liters of water. The invention can also be hooked up to a live water line via the water line port 9. In the preferred embodiment, there is a sensor inside of the water storage area that senses when the water level is low and causes the water sensing light 6 to change color in order to alert the user that the water needs to be refilled. Preferably the water sensor is a float sensor, but any other type of water level sensor, such as an optical or a microwave sensor, may be used in conjunction with the machine.

In the back of the machine is a carbon dioxide access door 3. The carbon dioxide access door 3 opens and through the carbon dioxide access door 3, a canister of carbon dioxide can be inserted into the machine. In a preferred embodiment, the user will use carbon dioxide canisters specially configured to work with the drink dispenser, but the drink machine may also be configured to work with small canisters of carbon dioxide that are commercially available. In a preferred embodiment, there is a sensor inside of the carbon dioxide storage area that senses when the carbon dioxide level is low which causes the carbon dioxide sensing light 4 to change color in order to alert the user that the dispenser needs a new canister of carbon dioxide. Preferably this sensor is an infrared sensor, but the sensor may be any other type of sensor such as a microwave, pressure, ultrasonic, capacitance sensor.

FIG. 11 shows the interior dimensions of the flavor injector 1000. The dimensions on the drawing are in inches and represent the dimensions useful to create the preferred syrup to water ratio. This view also shows a choke point 38. When the water from the water inlet 26 flows through the choke point 38, it creates a drop in pressure at the syrup inlet 28. The drop in pressure sucks the syrup into the flavor injector 1000. The syrup and the water mix inside the flavor injector 1000, and the mixed drink exits the flavor injector 1000 through the beverage outlet 30, to be dispensed out the nozzle 16.

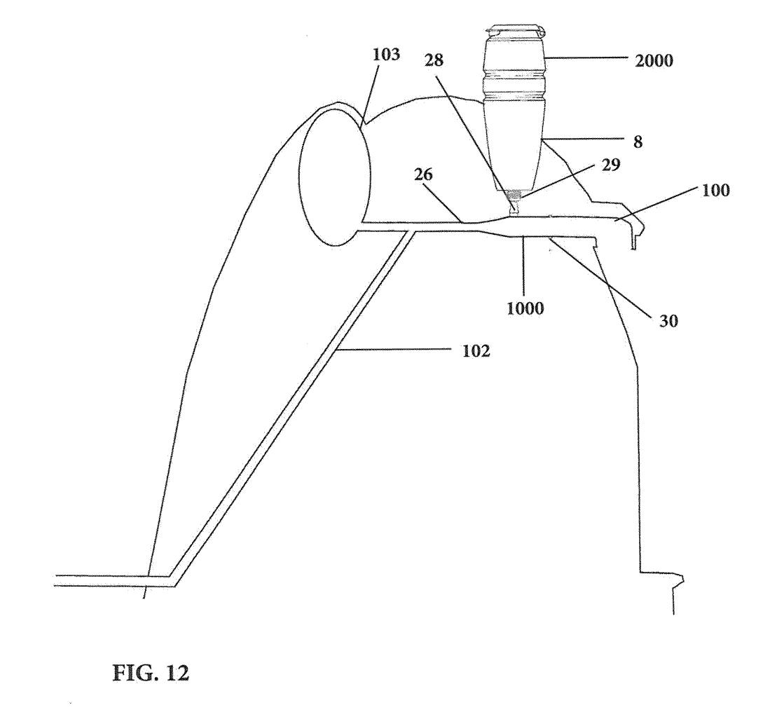

FIG. 12 shows how the flavor injector 1000 and the flavor bullet preferably interact inside of the machine. The drawing shows a basic outline of the machine. The drawing shows an approximate location of a carbon dioxide chamber 103, although location may vary. The flavor bullet 2000 has been inserted into the flavor port 8. The bottom of the flavor bullet 2000 sits atop the syrup inlet 28 of the flavor injector 1000. The water inlet 26 is connected to a water source 102. The water 102 and syrup both flow into the flavor injector 1000, and the mixed beverage 100 dispenses out the beverage outlet 30. Preferably there will be a sensor 29 at the intersection of the flavor bullet 2000 and the flavor injector 1000 that can detect when the syrup level is low and automatically shut off the water flow when the flavor bullet 2000 is empty. When the flavor bullet 2000 runs out of syrup, the water flow will stop until the cartridge 2000 is replaced or the door 9 to the flavor port 8 is closed. The sensor 29 may be any type of sensor such as a float, optical, microwave, or capacitance sensor. This drawing does not show all of the details of the inner workings of the invention, it is merely illustrative of how the flavor injector 1000 and flavor bullet 2000 interact.

When the drink dispenser mixes a carbonated drink, the water will be carbonated before it enters the water inlet 26 of the flavor injector 1000. Water may be carbonated by one of several different methods, preferably mixing water and carbon dioxide in a high pressure tank.

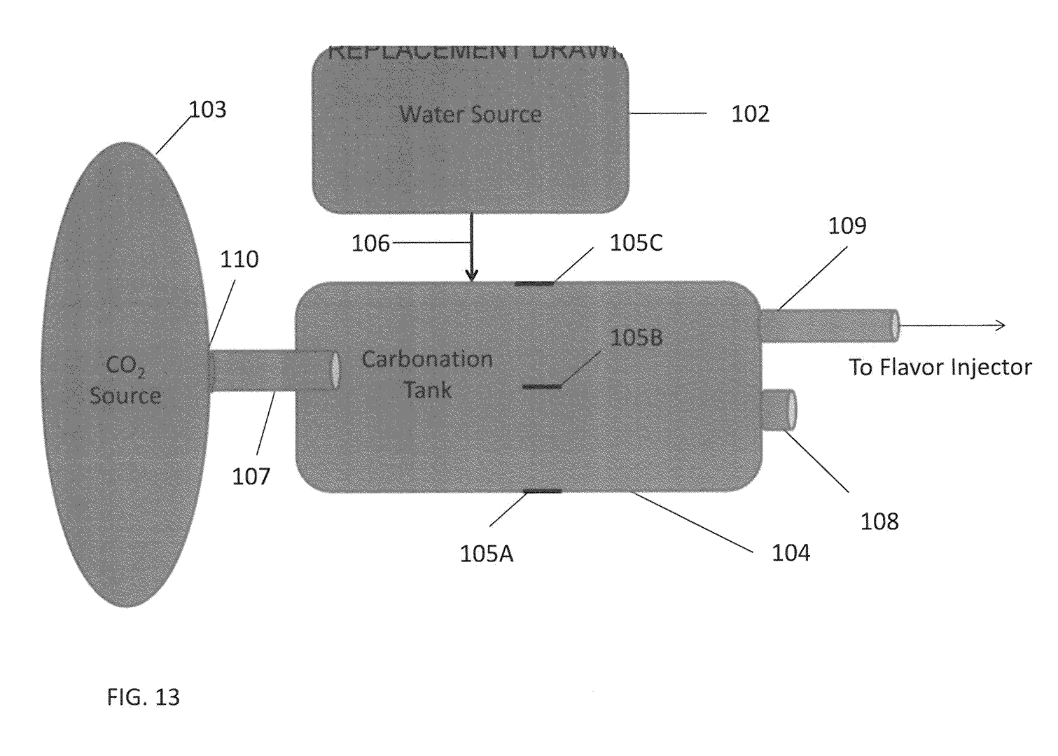

FIG. 13 shows a preferred method for mixing the carbon dioxide and water to create carbonated water. First, water from the water source 102 fills the carbonation tank 104. The carbonation tank 104 has three water level probes 105. When there is enough water in the carbonation tank 104 to reach the top water level probe 105C, the water pump 106 shuts off. After the water pump 106 shuts off, a solenoid 110 from the carbon dioxide source 103 opens, jetting carbon dioxide into the tank 104 via tapered tube 107. Carbon dioxide will be jetted into the tank 104 for eighteen seconds. After eighteen seconds the water travels out of the tank via a dispenser solenoid 109 to the flavor injector 1000. As the water leaves the tank 104, the carbon dioxide will continue to enter the tank in order to keep the pressure constant. If water is void from the middle probe 105B, preferably the eight ounce mark, or bottom probe 105A, an exhaust solenoid 108 will open evacuating excess pressure from the tank and allowing the tank to refill again. The pressure in the tank is operably kept at 135 PSI. If the tank fills from the middle probe 105B the carbon dioxide will jet for twelve seconds as opposed to eighteen.

It is to be noted that appended drawings illustrate only typical embodiments of this invention, are not to scale, and therefore not to be considered limiting of its scope, for the invention may admit to other equally effective embodiments which are appreciated by those skilled in the arts.

All features disclosed in this specification, including any accompanying claims, abstract, and drawing, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step of” in the clause as specified in 35 U.S.C. §112, paragraph 6 may not be intended as a means plus claim.

Disclosed in this invention is a beverage dispenser operationally configured to make and dispense beverages comprising a water source, a chiller connected to said water source, a flavor port configured to receive a flavor source, a flavor injector fluidly connected to the flavor source and a water source; and a discharge port for dispensing a beverage comprising flavor and water. Also disclosed is a system for dispensing beverages comprising: a housing containing a source for receiving water, wherein said water may be thermoelectrically chilled; a flavor injector through which said chilled water is introduced at a first point; a removably securable flavor bullet through which flavored syrup is injected into said flavor injector at a second point; and said flavor injector further comprising a third exit point through which said chilled water and syrup egress and may be subsequently dispersed. In addition, a method of dispensing a beverage wherein syrup and water are mixed via a dispenser that employs the Venturi effect is also part of this invention.

Disclosed is a method of mixing a beverage comprising the steps of: obtaining a flavor injector that has three orifices; moving water and concentrated flavor through said flavor injector to harness the Venturi principal to control flow and facilitate mixing of the flavor and water; and dispensing a mixed beverage for consumption by a user.

Disclosed is a flavor cartridge for use with a beverage system comprising: a pod, wherein said pod is configured to receive and hold flavor concentrates, and wherein said pod features at least one orifice with a size that permits the orderly and ratioed draining of syrup into a beverage mixing apparatus.

The invention claimed is:

1. A beverage dispenser operationally configured to make and dispense beverages comprising:
a water source;
a chiller connected to said water source;
a flavor port configured to receive a flavor source;
a flavor injector fluidly connected to the flavor source and a water source; and,
a discharge port for dispensing a beverage comprising flavor and water.

2. A beverage maker according to claim 1, wherein said water source is a live water line.

3. A beverage maker according to claim 1 further comprising a carbon dioxide source for carbonating said beverage.

4. A beverage maker according to claim 3 further comprising two buttons that control the dispensing of beverage wherein one button controls the dispensing of carbonated beverage and the other controls the dispensing of a noncarbonated beverage.

5. A beverage maker according to claim 4 further comprising a sensor to measure water level.

6. A beverage maker according to claim 4 further comprising a sensor to measure a carbon dioxide level.

7. A beverage maker according to claim 1 further comprising a removably securable flavor bullet.

8. A method of dispensing a beverage wherein flavored syrup and water are mixed via a dispenser that employs the Venturi effect.

9. A method of claim 8 where carbon dioxide is mixed with the water to create a carbonated beverage.

10. A system for dispensing beverages comprising:
a housing containing a source for receiving water, wherein said water may be thermoelectrically chilled;
a flavor injector through which said chilled water is introduced at the first point;
a removably securable flavor bullet through which flavored syrup is injected into said flavor injector at a second point; and,
said flavor injector further comprising a third exit point through which said chilled water and syrup egress and may be subsequently dispensed.
